(19) United States
(12) Patent Application Publication
(10) Pub. No.: US 2023/0202487 A1
(43) Pub. Date: Jun. 29, 2023

(54) ONBOARD DEVICE AND ORIENTATION CONVERTING METHOD

(71) Applicant: Faurecia Clarion Electronics Co., Ltd., Saitama (JP)

(72) Inventor: Akihiro KAWABATA, Saitama (JP)

(21) Appl. No.: 18/084,763

(22) Filed: Dec. 20, 2022

(30) Foreign Application Priority Data
Dec. 28, 2021 (JP) 2021-214335

(51) Int. Cl. B60W 40/107; B60W 40/13

(52) U.S. Cl. CPC B60W 40/107; B60W 40/13

(57) ABSTRACT

An onboard device includes a first learning unit that obtains gravity direction information caused by gravity by learning raw sensor information sensed by a sensor while the vehicle is not accelerated, a second learning unit that obtains travel direction information of the vehicle by learning the raw sensor information sensed by the sensor while the vehicle is accelerated; and a calculating unit that calculates an orientation conversion parameter for converting the raw information into the normalized information using the gravity direction information and the travel direction information. The raw sensor information is the acceleration information actually sensed by the sensor when the onboard device is installed in an arbitrary orientation in the vehicle, and the normalized sensor information is equivalent to the acceleration information that would be sensed by the sensor when the onboard device is installed in the vehicle with a specified orientation.

### CROSS REFERENCE TO RELATED APPLICATION

This patent application claims the benefit and priority of Japanese Patent Application No. 2021-214335, filed on Dec. 28, 2021, the disclosure of which is incorporated by reference herein in its entirety as part of the present application.

### FIELD

The present invention relates in general to a technology for processing sensor information of an acceleration sensor installed in a vehicle.

### BACKGROUND

Conventionally, in an IVI (In-Vehicle Infotainment) system that includes a navigation system, an ECU (Electronic Control Unit) or other onboard devices installed in a vehicle, estimating its position and posture is one of their important functions.

Acceleration sensors and angular velocity sensors are used for observing the motion of the vehicles in order to achieve this function. In recent years, sensors with six degrees of freedom (which means acceleration on three axes and angular velocity on three axes) have come to be used as sensors. When used as sensors for vehicular behavior, it is necessary to know parameters that indicate the orientation relationship between the vehicle and the sensors, so the sensor must be installed in the vehicle with a designated orientation. However, the operation for installing a sensor in a vehicle with a designated orientation is a delicate operation, and the sensor will not always be installed in the vehicle correctly.

In regard to this point, a car navigation device has been disclosed wherein, even if tilted in the front/rear direction with respect to the vehicle, the slope angle can be detected and the pitch angle of the vehicle can be detected accurately (referencing Patent Document 1—JP 2004-20207 A).

### SUMMARY

However, with the technology set forth in Patent Document 1, if a sensor has been installed tilted with respect to the crosswise direction of the vehicle, the sensor information that is acquired by the sensor will not be used correctly.

In contemplation of the point set forth above, the present application proposes an onboard device that is able to convert raw sensor information sensed by a sensor into normalized sensor information, which would be sensed by the sensor when the sensor is installed in the vehicle with a specified orientation, even if the sensor is installed with an arbitrary orientation in a vehicle.

In order to solve this issue, the present application discloses an onboard device installed in an arbitrary orientation in a vehicle, which has an acceleration sensor therein and converts raw information sensed by the sensor into normalized information. The onboard device comprises a first learning unit that obtains a gravity direction information caused by gravity by learning the raw sensor information sensed by the sensor while the vehicle is not accelerated, a second learning unit that obtains a travel direction information of the vehicle by learning the raw sensor information sensed by the sensor while the vehicle is accelerated; and a calculating unit that calculates an orientation conversion parameter for converting the raw information into the normalized information using the gravity direction information obtained by the first learning unit and the travel direction information obtained by the second learning unit. The raw sensor information is the acceleration information actually sensed by the sensor when the onboard device is installed in the arbitrary orientation in the vehicle, and the normalized sensor information is equivalent to the acceleration information that would be sensed by the sensor when the onboard device is installed in the vehicle with a specified orientation.

Given the structure set forth above, the constraints on the sensor installation orientation are eliminated because the orientation conversion is carried out on the raw sensor information depending on the orientation conversion parameter. For example, the sensor installation technician can install the sensor in the vehicle without considering its orientation. For example, it is possible to reduce a situation in which correct acceleration information cannot be obtained due to the mounting attitude of the sensor because the acceleration information in the gravitational direction and acceleration information in the travel direction, that is, the orientation conversion parameters are learned in the structure set forth above.

Even after the vehicle has been transferred to the user, the learning units can carry out the learning automatically at certain times that occur when the vehicle travels normally on a road, that is, for example, the first learning unit can carry out learning when the vehicle is stopped or traveling at a constant speed and is not turning, and the second learning unit can carry out learning when the vehicle is accelerating or decelerating and not turning. Therefore, tuning operation of the on-vehicle device by an installation worker is not required prior to shipment, and relearning is possible at any time even if the onboard device is reinstalled at different attitude.

The present application discloses an onboard device that is implemented without any installation limitation regarding sensor orientation. Other issues, structures and effects will be appreciated through an explanation of an embodiment below. “Onboard Device” may be called “In-Vehicle device”.

### DRAWINGS

FIG. 1 is a diagram showing an example of an onboard device according to a first embodiment;

FIG. 2 is a diagram showing an example of a structure relating to the onboard device according to the first embodiment;

FIG. 3 is a diagram showing an example of a structure relating to an orientation conversion parameter learning unit according to the first embodiment;

FIG. 4 is a diagram for explaining a calculation block according to the first embodiment;

FIG. 5 is a diagram showing an example of a flowchart relating to a first learning process according to the first embodiment; and

FIG. 6 is a diagram showing an example of a flowchart relating to a second learning process according to the first embodiment.

### DESCRIPTION

### (I) First Embodiment

One embodiment according to the present application will be described in detail below. Note that the present invention is not limited to this embodiment.

The onboard device according to the present embodiment converts raw sensor information, acquired from a sensor when installed with an arbitrary orientation in a vehicle, into normalized sensor information for which the sensor is installed in the vehicle with a specified orientation. The specified orientation may be the conventional installation orientation wherein the installation orientation is limited to, for example 0° in the horizontal direction and 0° in the travel direction with a 20° slope, or an installation orientation that is designated in advance. Here acceleration sensors for acquiring acceleration information are included in the installed sensor.

The onboard apparatus learns, for example, acceleration information for the gravitational direction from the gravitational component of the acceleration information acquired by the sensor. For ease in learning the acceleration information, in the onboard device, acceleration information may be processed based on prescribed rules (such as normalization), and learning may be carried out when prescribed conditions are satisfied, such as the vehicle being in a stopped state. The onboard device may learn acceleration information for the direction of travel of the vehicle from the gravitational direction acceleration information that has been learned along with acceleration information acquired from the sensor. At this time, for ease in learning the acceleration information, in the onboard device, normalization may be performed, and learning may be performed when prescribed conditions are satisfied, such as the vehicle accelerating while traveling in a straight line. The onboard device may use the learned gravitational direction acceleration information and learned travel direction acceleration information to calculate orientation conversion parameters for converting the first acceleration information, acquired from the sensor, into second acceleration information for when the sensor is installed in the vehicle with the specified orientation.

The structure set forth above enables the sensor to be secured in any orientation, because the orientation conversion parameters are learned from the behavior of the vehicle. This enables the sensor to be installed in the vehicle without the sensor installation technician having to worry about the installation orientation, for example, and enables the sensor performance to be sustained.

An embodiment according to the present application will be explained next based on the drawings. The descriptions and drawings below are for an illustrative example for explaining the present invention, and may be omitted or simplified as appropriate for clarity in the explanation. The present invention may be achieved in a variety of other forms. The individual structural elements may be singular or plural, without any particular limitation. Note that for identical elements in the drawings, identical numbers are assigned in the explanations below, and explanations thereof may be omitted as appropriate.

Note that descriptions, such as “first,” “second,” and “third,” in this specification, are added in order to identify the structural elements, and are not necessarily limiting in terms of quantities or sequence. The numbers for identifying structural elements are used in specific contexts, where a number used in one context does not necessarily indicate the same structure in another context. Furthermore, a structural element identified by a given number may also provide the function of a structural element identified by another number.

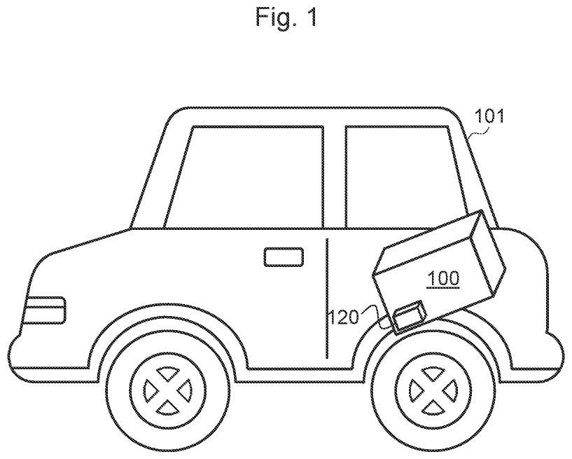

FIG. 1 is a diagram showing an example of an onboard device 100 according to a first embodiment.

An onboard device 100 is installed with an arbitrary orientation into a vehicle 101. A sensor 120 secured to an onboard device 200 is structured including an acceleration sensor as a device (sensor) for observing the behavior of the vehicle 101. The sensor 120 may include other sensors, such as angular velocity sensors. The explanation below will use, as an example, a structure where acceleration sensors and angular velocity sensors are included in the sensor 120. Note that while an example of an automobile is used in the explanation for the vehicle 101, there is no limitation to being an automobile.

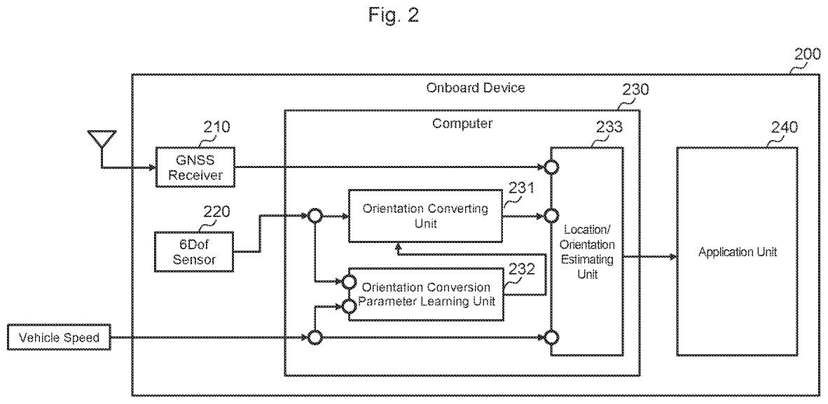

FIG. 2 is a diagram showing an example of a structure relating to the onboard device 100 including the sensor 120 of FIG. 1.

The onboard device 200 is an example of the onboard device 100 of FIG. 1 and includes a GNSS (Global Navigation Satellite System) receiver 210, a 6DoF (Six Degrees of Freedom) sensor 220, a computer 230 and an application unit 240.

The GNSS receiver 210 is a device that is able to measure the location of the vehicle 101 (able to acquire location information) through receiving radio signals from a position measurement satellite system.

The 6DoF sensor 220 is an example of the sensor 120 in FIG. 1, and is able to measure acceleration on three axes and angular velocity on three axes. For example, the 6DoF sensor 220 is a six-degree-of-freedom inertial measurement device (inertial measurement unit) wherein the axes of three acceleration sensors are mutually perpendicular and the axes of three angular velocity sensors are mutually perpendicular, where the three axes of the acceleration sensors correspond to the three axes of the angular velocity sensors. The explanation below assumes a structure where the three acceleration sensor axes and the three angular velocity sensor axes correspond to each other and are structured according to a right-handed coordinate system. The 6DoF sensor 220 may have a structure where individual sensors are arranged similarly (for example, a structure wherein three single-axis sensors are arranged perpendicular to each other), or a structure where multiple axes are combined and converted similarly (for example, in the case of an eight-axis acceleration sensor, a structure where the outputs are three mutually perpendicular axes). The 6DoF sensor 220 may have analog outputs or may have digital outputs.

The computer 230 includes a processor such as a CPU (Central Processing Unit), and a storing device such as a RAM (Random Access Memory) and/or a ROM (Read Only Memory). The functions of the computer 230 (such as the orientation converting unit 231, orientation conversion parameter learning unit 232, location/orientation estimating unit 233) may be achieved in software through a CPU reading out into RAM, and executing, a program that is stored in the ROM, or may be achieved in hardware through dedicated circuitry, or may be achieved through a combination of software and hardware. Note that one function of the computer 230 may be divided into a plurality of functions, or a plurality of functions may be combined into a single function. The units of the functions of the computer 230 may be designed as other functions, or may include other functions.

The orientation converting unit 231 uses orientation conversion parameters for orientation conversion of the acceleration information and angular velocity information acquired from the 6DoF sensor 220, from the reference frame of the 6DoF sensor 220 (the sensor frame) to the reference frame of the vehicle 101 (the vehicle frame), to convert into the acceleration information and angular velocity information for the vehicle 101 that is required by the location/orientation estimating unit 233.

The orientation conversion parameter learning unit 232 uses the acceleration information and angular velocity information acquired from the 6DoF sensor 220, along with information for the speed of the vehicle 101, to learn the orientation conversion parameters. The orientation conversion parameters may be learned continuously after the time that the vehicle 101 goes into use immediately after shipping of the vehicle 101, after completion of assembly within the factory, or the like. The speed information for the vehicle 101 is acquired from a vehicle speed sensor, not shown in the diagram, and inputted into the onboard device 200.

The location/orientation estimating unit 233 inputs location information from the GNSS receiver 210, acceleration information and angular velocity information for the vehicle 101 from the orientation converting unit 231, and speed information for the vehicle 101. The location/orientation estimating unit 233 uses the orientation conversion parameters, learned by the orientation conversion parameter learning unit 232, to estimate the location and orientation of the vehicle 101 from the inputted information, to output them to the application unit 240.

The application unit 240 is one or more application software or one or more devices that use the location and/or orientation of the vehicle 101, such as an IVI or an ECU.

After application of the power supply, the computer 230 continuously samples sensor information from the 6DoF sensor 220, at a known sampling rate. Upon the sensor information obtained from the 6DoF sensor 220 satisfying a prescribed condition, the computer 230 learns the orientation conversion parameters, but does not learn the orientation conversion parameters if the sensor information does not satisfy the prescribed condition. When the orientation conversion parameters have been learned, the computer 230 operates using the orientation conversion parameters, but if the orientation conversion parameters have not been learned, it operates using orientation conversion parameters from the past (for example, the orientation conversion parameters that were learned most recently).

Note that rather than the onboard device 200 including all the structural elements that are the GNSS receiver 210, the 6DoF sensor 220, and the application unit 240, a structural element that is not included the onboard device 200 may be included in another onboard device in the vehicle 101. Note also that the computer 230 may be an ECU, and may be included in the 6DoF sensor 220, or may be included in the application unit 240.

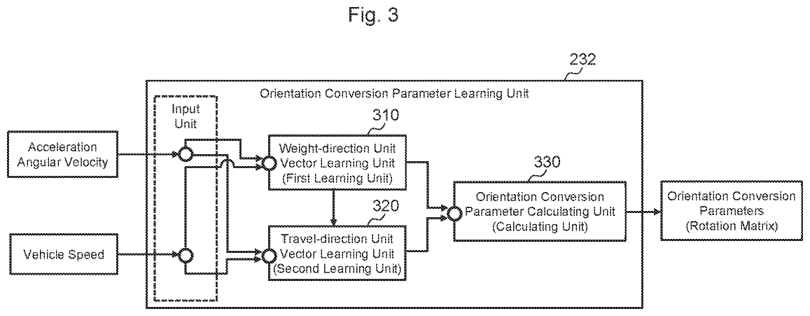

FIG. 3 is a diagram showing an example of a structure relating to the orientation conversion parameter learning unit 232.

The orientation conversion parameter learning unit 232 includes a weight-direction unit vector learning unit 310, a travel-direction unit vector learning unit 320, and an orientation conversion parameter calculating unit 330.

The weight-direction unit vector learning unit 310 is an example of the first learning unit, and learns (estimates) the degree of tilt, with respect to the gravitational direction, with which the 6DoF sensor 220 is installed. The weight-direction unit vector learning unit 310 learns the unit vector in the gravitational direction from the gravitational component that is apparent in the acceleration information (for example, the acceleration vector) that is detected by the acceleration sensor of the 6DoF sensor 220 when, for example, it is determined that the vehicle 101 is traveling at a constant speed or is stopped and the vehicle 101 is not turning.

The travel-direction unit vector learning unit 320 is an example of the second learning unit, which learns the degree of misalignment, with respect to the travel direction of the vehicle 101, with which the 6DoF sensor 220 is installed. The travel-direction unit vector learning unit 320 learns the unit vector in the travel direction, defining, as the travel-direction component, a difference between a past value of the acceleration sensor (for example, the acceleration information for the gravitational direction), and the current value (acceleration detection detected through the 6DoF sensor 220) when, for example, it is determined that there is acceleration in the vehicle 101 (the vehicle 101 is accelerating or decelerating) and that the vehicle 101 is not turning.

The orientation conversion parameter calculating unit 330 is an example of the calculating unit, and calculates a rotation matrix, as the orientation conversion parameters, from the unit vector in the gravitational direction, learned from the weight-direction unit vector learning unit 310, and the unit vector in the advancing direction, learned from the travel-direction unit vector learning unit 320.

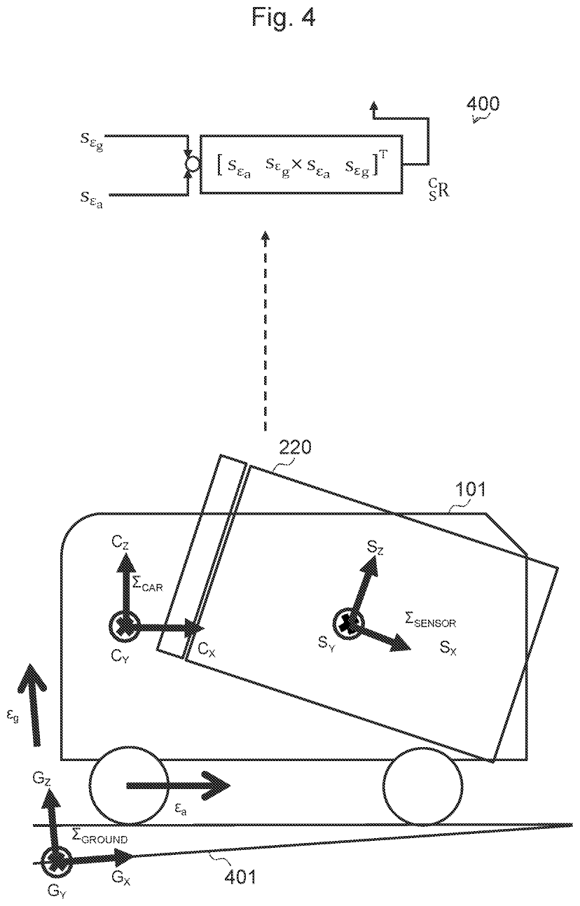

FIG. 4 is a diagram for explaining a calculation block 400 relating to calculating the orientation conversion parameters.

The parameters in calculating the orientation conversion parameters will be explained first. Σ_{CAR}, shown in FIG. 4, indicates a frame in a right-handed system wherein the forward direction of the vehicle 101 is defined as the X-axis positive direction, and the upward direction of the vehicle 101 is defined as the Z-axis positive direction. The crosswise direction (the width direction) of the vehicle 101 is defined as the Y axis. Σ_{SENSOR} indicates a frame of a right-handed system wherein the 6DoF sensor 220 is installed arbitrarily. Σ_{GROUND} indicates a frame of a right-headed system wherein the direction of a line that is tangent to an ideal ground surface 401 (for example, a unit vector in the travel direction of the vehicle 101, projected onto the ideal ground surface 401) is defined as the X axis, and the gravitational direction (for example, the unit vector of the gravitational acceleration g) is defined as the Z axis.

ε_{g} represents a unit vector indicating the acceleration in the gravitational direction. Eₐ represent a unit vector that indicates acceleration in the direction of travel of the vehicle 101. ^{A}_{B}R indicates a suffix expression in a matrix R (an expression for an orientation matrix of a frame B viewed from a frame A). ^{A}v indicates a suffix expression for the vector v. Additionally, in the matrix R^{T} and the vector v^{T}, the suffix expression T on the upper right indicates the transposition of the matrix R and the vector v, respectively.

The algorithm for calculating the orientation conversion parameters will be explained next. Here let us consider “(problem a)” in calculating the orientation conversion parameters.
(Problem a): Expressing, as detection values in the vehicle frame, the detection values in the sensor frame that appear on the detection axes of the 6DoF sensor 220 when the 6DoF sensor 220 is installed in an arbitrary orientation

For example, when a vector in the sensor frame of the 6DoF sensor 220 is defined as ^{S}a, and this is mapped onto a vector ^{C}a viewed from the vehicle frame, (Equation 1), below, is derived using the orientation matrix of the sensor frame when viewed from the vehicle frame.

^{C}A=^{C}_{S}R^{S}a (Equation 1)

Consequently, (Problem a) can be rewritten as “(Problem a′) below:
(Problem a′): Calculating a transformation matrix CSR that is a map of the orientation of the sensor frame when viewed from the vehicle frame.

If here the sensor frame and vehicle frame are frames of an orthogonal three-axis right-handed system ^{C}_{S}R will be a rotation matrix.

Under conditions of traveling straight while accelerating, the unit vector when viewed from the vehicle 101, wherein the acceleration direction of the acceleration of the vehicle 101 is defined as positive, is defined as ^{C}εₐ, and the unit vector when viewed from the 6DoF sensor 220 is defined as ^{S}εₐ. When the vehicle 101 is on a horizontal surface, that is, under the condition of Σ_{CAR}=Σ_{GROUND}, the unit vector when viewed from the vehicle 101 wherein the direction of acceleration of gravitational acceleration is defined as positive (the direction normal to the surface of the ground in the upward direction) is defined as ^{C}ε_{g} and the unit vector when viewed from the 6DoF sensor 220 is defined as ^{S}ε_{g}. In this case, (Equation 2) and (Equation 3), below, are derived from (Equation 1):

^{C}εₐ=^{C}_{S}R^{S}εₐ (Equation 2)

^{C}ε_{g}=^{C}_{S}R^{S}ε_{g} (Equation 3)

Here ^{C}εₐ=[1 0 0]^{T} and ^{C}ε_{g}=[0 0 1]^{T}. The characteristics of rotation matrices and the assumption that all of the axes of the frame are perpendicular to each other enables the following transformations:

[^{C}εₐ ^{C}ε_{g}×^{C}εₐ ^{C}ε_{g}]=^{C}_{S}R[^{S}εₐ ^{S}ε_{g}×^{S}εₐ ^{S}ε_{g}]

I=^{C}_{S}R[^{S}εₐ ^{S}ε_{g}×^{S}εₐ ^{S}ε_{g}]

^{C}_{S}R=[^{S}εₐ ^{S}ε_{g}×^{S}εₐ ^{S}ε_{g}]^{T}

That is, ^{C}_{S}R can be derived uniquely through deriving the two vectors below. That is, the algorithm for calculating the orientation conversion parameters will be as the calculation block 400:
The unit vector ^{S}ε_{g}, when viewed from the sensor frame, of gravitational acceleration under the condition of being on a horizontal surface;
The unit vector ^{S}εₐ, when viewed from the sensor frame, of the vehicle acceleration under the conditions of accelerating during straight travel.

Note that the sensor 120 that is installed is not limited to a 6DoF sensor 220. The installed sensor 120 may be an acceleration sensor able to acquire acceleration information in three directions, having three axes that are mutually perpendicular. In this case, the calculating unit uses the unit vector ^{S}ε_{g} for the acceleration information in the gravitational direction, learned by the first learning unit, and the unit vector ^{S}εₐ for the acceleration information in the direction of travel, learned by the second learning unit, to calculate the rotation matrix [^{S}εₐ ^{S}ε_{g}×^{S}εₐ ^{S}εₐ]^{T} as the orientation conversion parameters.

In the structure above, the acceleration information acquired by the sensor 120 is acceleration information in three directions wherein at least three axes are mutually perpendicular, making it possible to calculate the orientation conversion parameters by calculating the unit vector for the gravitational direction and the unit vector for the direction of travel.

The sensor 120 that is installed may include angular velocity sensors that are able to acquire angular velocity information in three directions that have three mutually perpendicular axes. In this case, the three axes for acceleration information and the three axes for angular velocity information are coincident.

In the structure above, the angular velocity information acquired by the sensor 120 is angular velocity information in three directions wherein the three axes are mutually perpendicular, and the three axes for the acceleration information correspond to the three axes for angular velocity information, enabling the use of the same rotation matrix, as the orientation conversion parameters, for the angular velocity information as for the orientation conversion parameters for the acceleration information. Moreover, in the structure above, the rotation matrix is learned, for example, making possible to reduce situations wherein correct angular velocity information is not available due to the orientation with which the sensor 120 is installed.

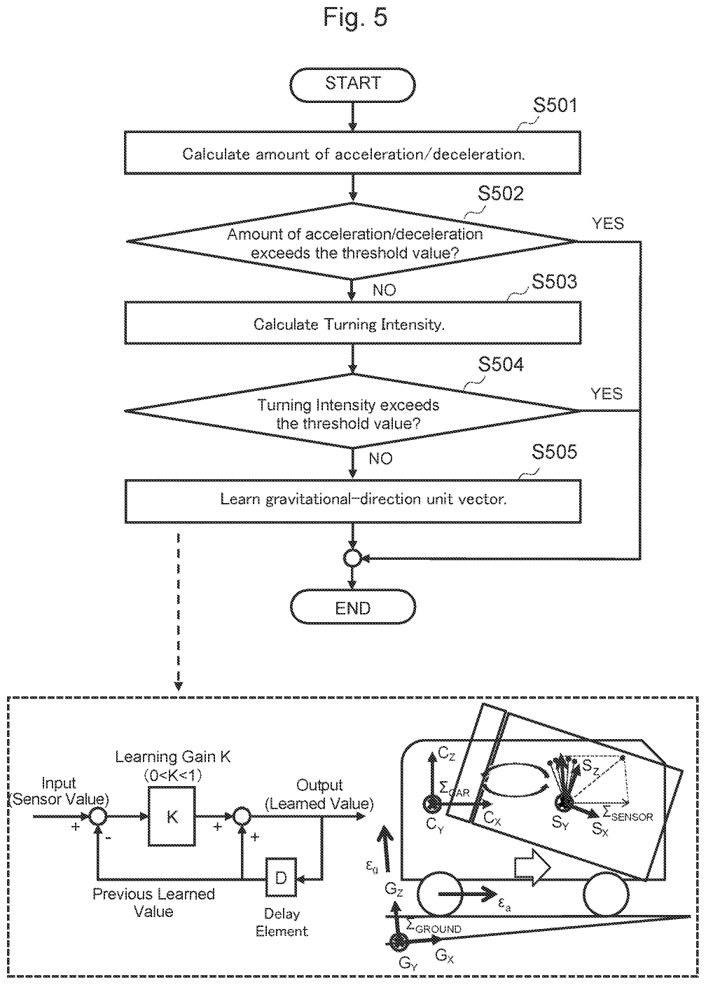

FIG. 5 is a diagram showing an example of a flowchart relating to a process (first learning process) for learning the gravitational-direction unit vector. In the first learning process, the onboard device 200 learns the gravitational-direction unit vector when the vehicle 101 is at a constant speed and the vehicle 101 is not turning.

In S501, the onboard device 200 calculates the absolute value of the difference in the speed information of the vehicle 101 (the amount of acceleration/deceleration).

In S502, the onboard device 200 evaluates whether or not the amount of acceleration/deceleration exceeds a threshold value. If the evaluation is that the amount of acceleration/deceleration exceeds the threshold value, the onboard device 200 terminates the first learning process, but if the evaluation is that the amount of acceleration/deceleration does not exceed the threshold value, processing moves to S503. When the vehicle 101 accelerates or decelerates, there will be a shift in the outputs of the 6DoF sensor 220. That is, it will be uncertain how far the gravitational direction vector will be from the true value, and thus a constant speed is the appropriate condition for learning.

S503, the onboard device 200 calculates the root mean square (RMS) of the angular velocity components of the angular velocity information acquired from the 6DoF sensor 220. In the below, hereinafter this RMS will be referred as “Turning Intensity”. The onboard device 200 may calculate and use the magnitude of the transverse acceleration, as described below in S603, instead of the Turning Intensity.

In S504, the onboard device 200 evaluates whether or not the Turning Intensity exceeds a threshold value. If the evaluation is that the Turning Intensity exceeds the threshold value, the onboard device 200 terminates the first learning process, but if the evaluation is that the Turning Intensity is not greater than the threshold value, processing advances to S505. If the vehicle 101 were turning, a vector would be produced in the crosswise direction of the vehicle 101, producing a synthetic angle. That is, it would be difficult to approach the true value, and thus the vehicle 101 not turning is an appropriate condition for learning.

In S505, the onboard device 200 learns the gravitational-direction unit vector. The onboard device 200 inputs normalized values for the acceleration vectors of the 6DoF sensor 220, and causes convergence depending on the difference from the previous learned value. While the convergence filter (control device) is explained in the present embodiment with a learning gain K (<1), it may instead use a Wiener filter, a Kalman filter, an adaptive filter, or the like.

For example, the onboard device 200 converts the acceleration vector of the 6DoF sensor 220 into a vector in the same direction with a length of “1” (for example, through normalizing through a rolling average filter), and calculates the current learned value through (Equation 4), below:

Current learned value=Learned value from the previous cycle+Learning gain K×(Current sensor value−Learned value from the previous cycle) (Equation 4).

In this way, the onboard device 200 comprises an input unit for inputting speed information for the vehicle 101, and the first learning unit evaluates, based on the speed information inputted by the input unit, whether or not the acceleration or deceleration of the vehicle 101 in the direction of travel exceeds a threshold value. The first learning unit evaluates, based on the angular velocity information acquired by the 6DoF sensor 220, whether or not the vehicle 101 is turning. Upon an evaluation that the acceleration or deceleration of the vehicle 101 in the direction of travel does not exceed the threshold value, and that the vehicle 101 is not turning, the first learning unit learns the gravitational direction acceleration information unit vector ^{S}ε_{g} from the gravitational component of the acceleration information obtained from the 6DoF sensor 220.

In the structure above, the gravitational-direction unit vector ^{S}ε_{g} is learned in a situation wherein there is little effect on the direction of gravity, for example, enabling the convergence to be achieved quickly.

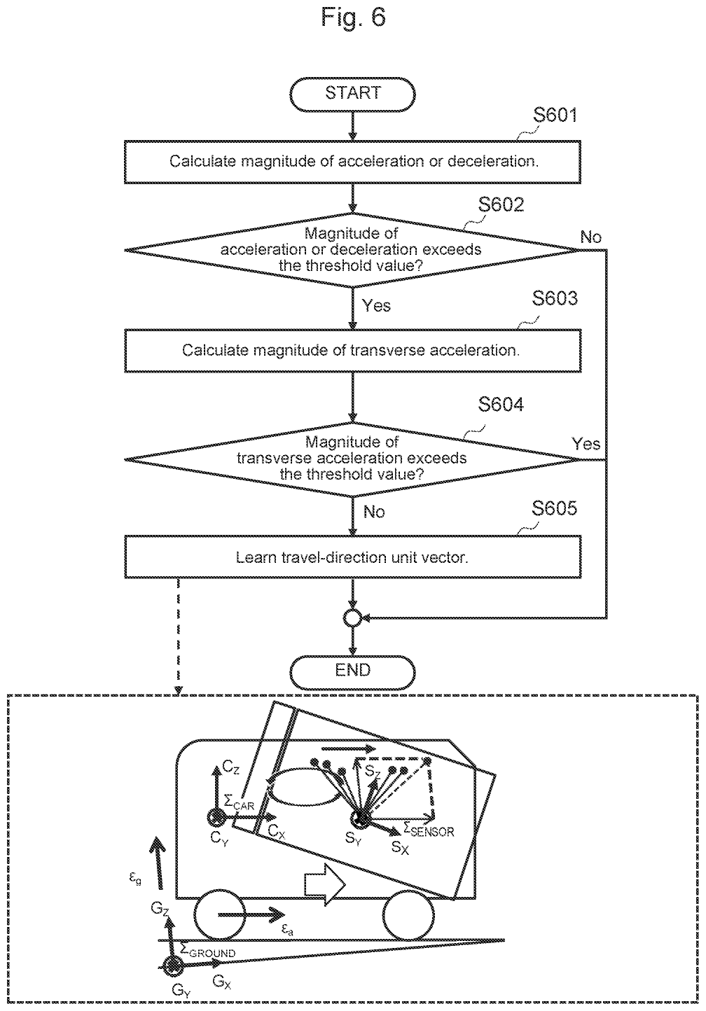

FIG. 6 is a diagram showing an example of a flowchart relating to a process (the second learning process) for learning the unit vector in the direction of travel. In the second learning process, the travel-direction unit vector is learned with the changes in the three axial components of the acceleration sensor of the 6DoF sensor 220 that appear when the vehicle 101 is not producing a Coriolis force in the crosswise direction (that is, when the vehicle 101 is not undergoing centripetal acceleration) during acceleration or deceleration, to learn the unit vector in the direction of travel.

In S601, the onboard device 200 calculates the absolute value of the difference of the speed information for the vehicle 101 (the amount of acceleration/deceleration).

In S602, the onboard device 200 evaluates whether or not the amount of acceleration/deceleration exceeds a threshold value. If the evaluation is that the amount of acceleration/deceleration exceeds the threshold value, the onboard device 200 jumps to the process in S603, but if the evaluation is that the amount of acceleration/deceleration is not greater than the threshold process, the second learning process is terminated.

In S603, the onboard device 200 calculates the absolute value of the value wherein the speed of the vehicle 101 is multiplied by the inner product of the gravitational-direction unit vector (the learned value) and the vector for the angular velocity information of the angular velocity sensor of the 6DoF sensor 220 (where this absolute value is the magnitude of the transverse acceleration).

In S604, the onboard device 200 evaluates whether or not the magnitude of the transverse acceleration exceeds a threshold value. If the evaluation is that the magnitude of the transverse acceleration exceeds the threshold value, the onboard device 200 terminates the second learning process, and if the evaluation is that the magnitude of transverse acceleration is not greater than the threshold value, processing advances to the S605.

Note that the onboard device 200 may perform the processes in S503 and S604 instead of the processes in S603 and S604.

In S605, the onboard device 200 learns the travel-direction unit vector. For example, the onboard device 200 uses the unit vector in the gravitational direction from the previous cycle as the direction vector and performs unit conversion into acceleration. Although the gravitational-direction unit vector is normalized, the vector for the acceleration sensor is not normalized, so the onboard device 200 uses the gravitational-direction unit vector as the acceleration dimension (aligning the unit dimension). The onboard device 200 calculates the difference between the unit-converted direction vector and the current acceleration vector (calculating a relative vector). Following this, the onboard device 200 normalizes the relative vector, and in order to align the direction of the vectors during deceleration and acceleration, for deceleration takes the additive inverse of the normalized vector using the sign of the difference value of the speeds in the vehicle 101. Following this, the onboard device 200 inputs the vector that has been normalized and for which the sign has been reconciled, and causes convergence through the difference from the travel-direction unit vector of the previous cycle (the learned value from the previous cycle). While the convergence filter (control device) is structured in the present embodiment with a typical learning gain K, it may instead use a Wiener filter, a Kalman filter, an adaptive filter, or the like.

Note that the second learning process is not limited to the process described above. For example, the onboard device 200 may normalize the relative vector, for the current acceleration vector, with respect to the unit-converted value of the gravitational-direction unit vector (the learned value), doing so as-is if during acceleration, but if during deceleration uses a relative vector for which the direction has been aligned through taking the additive inverse, and may calculate the current learned value through (Equation 4), above.

In this way, the onboard device 200 comprises an input unit for acquiring speed information for the vehicle 101, and the second learning unit evaluates, based on the speed information inputted through the input unit, whether or not the acceleration of the vehicle 101 in the direction of travel exceeds a threshold value. The second learning unit evaluates, based on the speed information inputted from the input unit, whether or not the deceleration of the vehicle 101 in the travel direction exceeds the threshold value. The second learning unit evaluates, based on the angular velocity information acquired from the 6DoF sensor 220, whether or not the vehicle 101 is turning. Upon an evaluation that the acceleration of the vehicle 101 in the direction of travel exceeds the threshold value and evaluation that the vehicle 101 is not turning, the second learning unit uses a relative vector wherein the vector for the acceleration information in the gravitational direction, learned by the first learning unit, has been subtracted from the vector for the acceleration information obtained from the 6DoF sensor 220, to learn the unit vector ^{S}εₐ for the acceleration information in the direction of travel of the vehicle 101. Upon evaluation that deceleration of the vehicle 101 in the direction of travel exceeds the threshold value and evaluation that the vehicle 101 is not turning, the acceleration information acquired from the 6DoF sensor 220 is subjected to additive inversion, and a relative vector wherein the vector for the gravitational direction acceleration information, learned by the first learning unit, is subtracted from the vector for the acceleration information, which has undergone additive inversion, to learn the unit vector ^{S}εₐ for the acceleration information in the direction of travel of the vehicle 101.

The structure set forth above learns the travel-direction unit vector ^{S}εₐ using, for example, acceleration information for when the vehicle 101 is accelerating, and acceleration information for when the vehicle 101 is decelerating, enabling rapid convergence of the learning.

While here the explanation was for learning the travel-direction unit vector during both acceleration and deceleration in the second learning process, the travel-direction unit vector may instead be learned during either deceleration or deceleration alone.

For example, upon evaluation that the acceleration of the vehicle 101 in the direction of travel exceeds a threshold value, and evaluation that acceleration of the vehicle 101 in the crosswise direction does not exceed a threshold value, the second learning unit learns the unit vector ^{S}εₐ for the acceleration information in the direction of travel of the vehicle 101 from the acceleration information for the gravitational direction, learned from the first learning unit, and acceleration information obtained from the 6DoF sensor 220.

In the structure above, the unit vector ^{S}εₐ in the direction of travel is learned, for example, when the acceleration in the direction of travel is large and the effect in the crosswise direction is small, enabling rapid convergence.

Upon evaluation that the deceleration of the vehicle 101 in the direction of travel exceeds a threshold value, and evaluation that acceleration of the vehicle 101 in the crosswise direction does not exceed a threshold value, the second learning unit learns the unit vector s_{εa} for the acceleration information in the direction of travel of the vehicle 101 from the acceleration information for the gravitational direction, learned from the first learning unit, and acceleration information obtained from the 6DoF sensor 220.

In the structure above, the unit vector ^{S}εₐ in the direction of travel is learned, for example, when the deceleration in the direction of travel is large and the effect in the crosswise direction is small, enabling rapid convergence.

### (II) Addendum

The embodiment described above may include, for example, details such as the following.

While the embodiment above was described for a case that is applied to an onboard device, the present invention is not limited thereto, but rather may be applied broadly to a variety of other systems, devices, methods, and programs.

Some or all of the program in the embodiment set forth above may be installed from a program source into a device such as a computer that achieves the onboard device. The program source may be, for example, a program distribution server that is connected to a network, or a computer-readable recording medium (for example, a non-volatile recording medium). Moreover, in the explanation above, a plurality of programs may be structured as a single program, or a single program may be structured through a plurality of programs.

Additionally, in the explanation above, information such as programs, tables, files, and the like, by which to achieve the various functions may be placed in a storage device, such as a memory, hard disk, or SSD (Solid State Drive), or on a recording medium such as an IC card, SD card or DVD.

The structures described above may be modified, reconfigured, combined, or omitted within a range that does not deviate from the spirit and intent of the present invention.

Items included in a list in the form of “A, B, and/or C” should be understood as including the meanings of “A, B, and C,” “A and B,” “A and C,” “B and C” or “A, B, and C.” Items included in a list in the form of “at least one of A, B or C” should be understood as including the meanings of “A, B, and C, “A and B,” “A and C,” “B and C” or “A, B, and C.”

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### EXPLANATIONS OF REFERENCE SYMBOLS

100, 200: Onboard Device
101: Vehicle
120: Sensor

1. An onboard device installed in an arbitrary orientation in a vehicle, which has an acceleration sensor therein and converts raw sensor information sensed by the sensor into normalized sensor information, the onboard device comprising:
a first learning unit that obtains a gravity direction information caused by gravity by learning the raw sensor information sensed by the sensor while the vehicle is not accelerated;
a second learning unit that obtains a travel direction information of the vehicle by learning the raw sensor information sensed by the sensor while the vehicle is accelerated; and
a calculating unit that calculates an orientation conversion parameter for converting the raw information into the normalized information using the gravity direction information obtained by the first learning unit and the travel direction information obtained by the second learning unit;
wherein the raw sensor information is the acceleration information actually sensed by the sensor when the onboard device is installed in the arbitrary orientation in the vehicle, and the normalized sensor information is equivalent to the acceleration information that would be sensed by the sensor when the onboard device is installed in the vehicle with a specified orientation.

2. The onboard device according to claim 1, wherein the sensor is able to sense the acceleration information having components of three axes perpendicular to each other, and the calculating unit calculates a rotation matrix [^{S}εₐ ^{S}ε_{g}×^{S}εₐ ^{S}εₐ]^{T} as the orientation conversion parameter, using a unit vector ^{S}ε_{g} representing the gravity direction information obtained by the first learning unit, and a unit vector ^{S}εₐ representing the travel direction information obtained by the second learning unit.

3. The onboard device according to claim 2, wherein the sensor is able to sense the acceleration information having components of three axes perpendicular to each other; and to sense an angular velocity information having components of the same three axes.

4. The onboard device according to claim 2, wherein the first learning unit obtains the unit vector ^{S}ε_{g} representing the gravity direction information by learning the raw sensor information sensed by the sensor while the vehicle is traveling at a constant speed without turning.

5. The onboard device according to claim 2, wherein the second learning unit obtains unit vector ^{S}εₐ representing the travel direction information by learning the raw sensor information sensed by the sensor while the vehicle is accelerating or decelerating its speed without turning.

6. The onboard device according to claim 2, wherein the first learning unit obtains a gravity vector representing the gravity direction information, and the second learning unit obtains the unit vector ^{S}εₐ representing the travel direction information by learning a relative vector that is acquired by subtracting the gravity vector from a vector representing the raw information sensed by the sensor.

7. The onboard device according to claim 6, wherein the second learning unit obtains unit vector ^{S}εₐ representing the travel direction information by learning the relative vector while the vehicle is accelerating or decelerating its speed without turning.

8. The onboard device according to claim 7, the second learning unit obtains the unit vector ^{S}εₐ representing the travel direction information by learning a relative vector that is acquired by subtracting the gravity vector from the inverted value of the vector representing the raw information sensed by the sensor while the vehicle is decelerating its speed without turning.

9. An orientation converting method for converting raw sensor information sensed by an acceleration sensor into normalized sensor information, the sensor is embedded in an onboard device installed in an arbitrary orientation in a vehicle, the method comprising the steps of:
obtaining a gravity direction information caused by gravity by learning the raw sensor information sensed by the sensor while the vehicle is not accelerated;
obtaining a travel direction information of the vehicle by learning the raw sensor information sensed by the sensor while the vehicle is accelerated; and
calculating an orientation conversion parameter for converting the raw information into the normalized information using the gravity direction information and the travel direction information;
wherein the raw sensor information is the acceleration information actually sensed by the sensor when the onboard device is installed in the arbitrary orientation in the vehicle, and the normalized sensor information is equivalent to the acceleration information that would be sensed by the sensor when the onboard device is installed in the vehicle with a specified orientation.
